(19) United States
(12) Patent Application Publication
(10) Pub. No.: US 2004/0250841 A1
(43) Pub. Date: Dec. 16, 2004

(54) HVAC enviro-clean condensate drain pan and coil cleaning system

(76) Inventors: Atwood M. Kimbrough, Pace, FL (US); Carl Brian Kimbrough, Milton, FL (US); Carla S. Cross, Graceville, FL (US)

Correspondence Address: Atwood M. Kimbrough, P O Box 1081, Pace, FL, 32571, US

(21) Appl. No.: 10/457,230

(22) Filed: Jun. 10, 2003

(51) Int. Cl. B08B 3/04

(52) U.S. Cl. 134/56 R; 134/166 R; 134/104.1; 134/115 R; 134/201

(57) ABSTRACT

Currently, there are no products available which allow a user to treat microbial and bacterial growth inside a HVAC condensate drain pan without first, gaining access to the drain pan by removal of the front cover of the HVAC unit. Our HVAC Enviro-Clean Condensate Drain Pan and Coil Cleaning System will accommodate the introduction of non-corrosive algaecides and/or biocides and cleaner fluids via an internal reservoir and plastic hosing system that can be easily used and maintained by the consumer. A reduction of microbial and bacterial growth will have a positive impact of Indoor Air Quality.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

The field of endeavor to which our invention pertains is Heating, Ventilation and Air Conditioning (HVAC) for the home, office, and apartment or wherever a heating and cooling air-handling unit may be installed.

Current technology addressing HVAC problems our invention solves is as follows:

1. To disinfect an HVAC unit internally, algaecide tablets or other disinfectants are added to the drain pan by removing the front cover of the HVAC unit and placing or spraying the disinfectant into the drain pan and cooling coils. This is very cumbersome and usually has to be performed by a HVAC technician and has not been widely accepted by consumers and normally is discontinued until a blockage to the drain pan or line from microbial growth has re-occurred and an overflow problem has again presented itself.

2. Algae and microbial growth accumulations can also be removed by use of a vacuum suction which can be attached to the condensate drain line or by removing the front cover of the HVAC unit to gain access to the drain pan. This results in an expensive cost to the consumer and is often discontinued because of inconvenience and cost. The vacuum suction removal method usually leaves a considerable amount of residual growth in the drain pan due to the inability to see the microbial deposits while removing them.

### BRIEF SUMMARY OF THE INVENTION

One of the most common problems that a user of a HVAC system faces, is that of clogged and overflowing condensate drain pans and drain lines caused by microbial growth accumulations. Typically, when this occurs, the owner or user of the HVAC system must call a repairman to cut the drain line to remove the blockage, remove the HVAC front cover, clean the cooling coils and drain pan and reassemble the parts for normal use. This usually occurs numerous times during the life of the HVAC system and results in a costly expense for the consumer for the service call and repair. Additional costs and inconvenience are incurred from damage to carpets and building or dwelling interior. All of the spillages are a detriment to Indoor Air Quality (IAQ).

Current HVAC system installations do not include a method whereby the condensate drain pan and drain line and cooling coils can be cleaned and treated to remove microbial growth without considerable expense to the consumer.

The instant invention allows for easy cleaning and maintenance access whereby the consumer can easily treat the condensate drain pan and drain line and cooling coils with a non-corrosive algaecide or biocide liquid and coil cleaner to minimize the potential for microbial and algae growth while favorably affecting Indoor Air Quality.

The primary value of this product to consumers and HVAC system owners is as follows:

1: Economic: Installation can be made during the initial manufacture of the HVAC unit. A retro-fit can be made to older HVAC units already in place, dependent upon the unit configuration, by qualified HVAC technicians. Continuous routine cleaning and treatment of the condensate drain pan, drain line and cooling coils throughout the life of the HVAC unit can by made by the consumer cheaply, safely and easily.

2: Environmentally safe: Non-corrosive algaecides or biocides and cleaning fluids can be added to the drain pan and cooling coils to eliminate most of the microbial, bacterial and algae growth that may occur in the drain pan and drain line and cooling coils without harming the environment.

3. Indoor Air Quality: By reducing microbial and algae growth and reducing drain pan spillages onto carpeting and interior of homes and buildings, Indoor Air Quality will be favorably affected.

### BRIEF DESCRIPTION OF THE SEVERAL VIEWS OF THE DRAWING

FIG. 1: HVAC Unit Typical Installation

FIG. 2: HVAC Enviro-Clean Drain Pan and Coil Cleaning System Installation

FIG. 3: Upper Cleaning Fluid Delivery Apparatus

FIG. 4: Fluid Reservoir and Flow Line

FIG. 5: Plastic Clip Hangers for Hose placement in Drain Pan

FIG. 6: Condensate Flow Patterns

FIG. 7: Fluid Flow Lines and Fluid Distribution Lines

FIG. 8: Upper and Lower Fluid Distribution Line Placement

FIG. 9: Cleaning Fluid Flow Pattern from Lower Distribution Lines

FIG. 10: Cleaning Fluid Flow Pattern from Upper Distribution Line through Cooling Coils

FIG. 11: Flow Pattern from Upper Distribution Line into and through Drain Pan

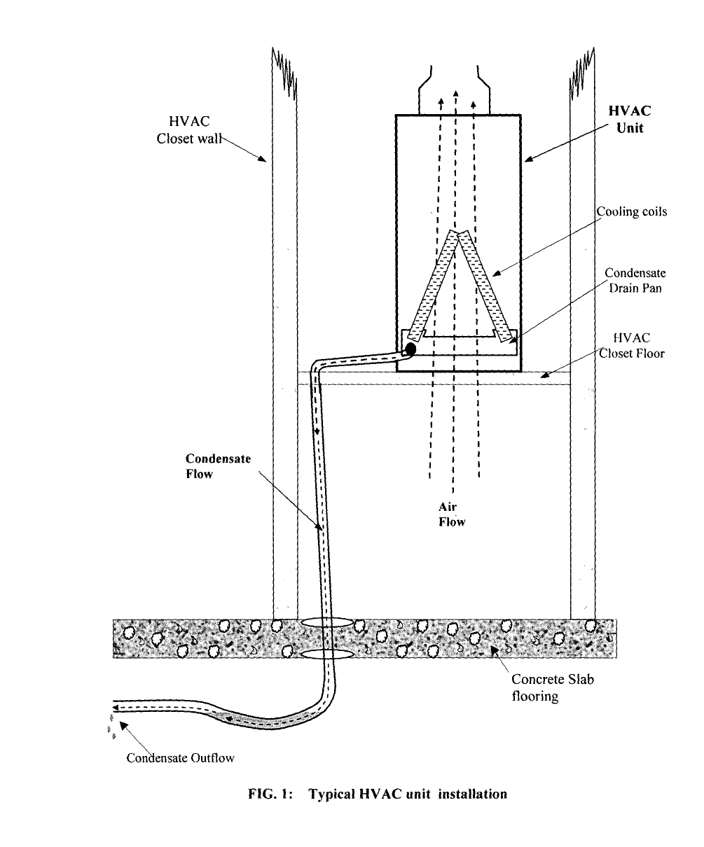

### DETAILED DESCRIPTION OF THE INVENTION

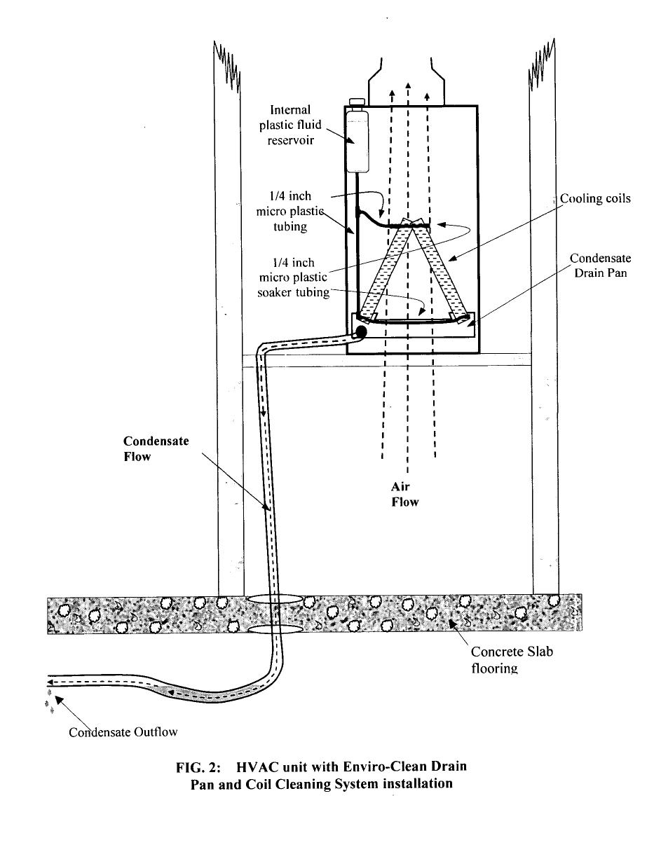

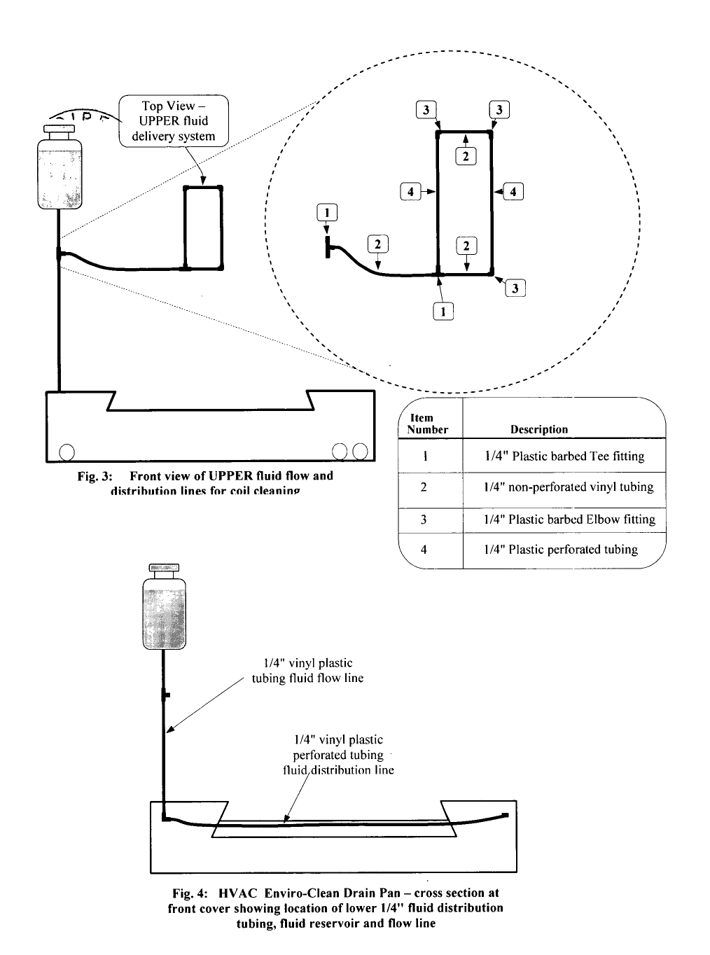

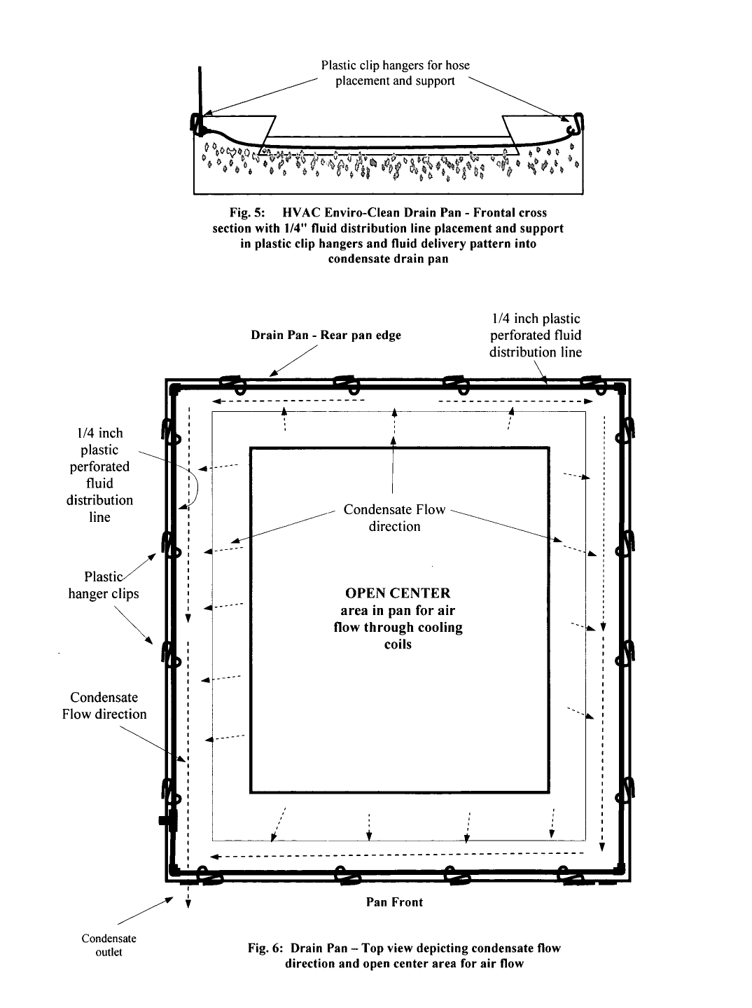

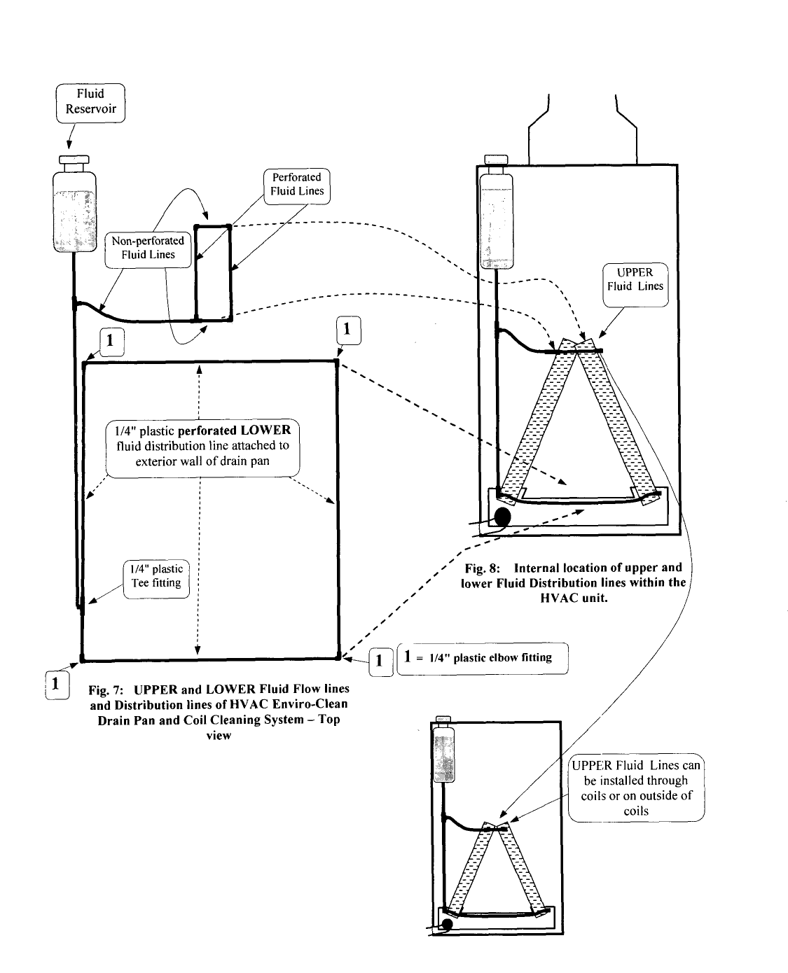

The instant invention is composed of a Poly Vinyl Chloride (PVC) or similar plastic bodied fluid collection pan being 19.75 inches in length, 14.75 inches in width and having a fluid collection area 2.625 inches wide on each side and 1.5 inches wide on the distal end and 2.1875 inches wide on the drain outlet or proximal end; an interior open area in the pan center measuring 7.875 inches wide by 16 inches in length allows for air flow from the return air opening to and through the cooling coils of the HVAC unit. Outlet ports on the drain pan for condensate removal are located on each side of the front end of the drain pan for connection to a condensate drain line (See FIGS. 3, 4, 6). Pan dimensions will vary dependent upon the configuration of the HVAC unit manufacturer. Secondly, a fluid delivery system is composed of an internal plastic fluid reservoir attached to ¼″ plastic tubing fluid flow line which is further attached to (1) an upper fluid distribution line for delivery of cleaning and disinfectant fluids to the upper part of the HVAC cooling coils, which sweep down the coils intermingled with condensation and into the interior portion of the drain pan and (2) attached to a lower fluid distribution line for fluid delivery to the exterior portion of the HVAC drain pan (See FIGS. 2, 7, 8).

The HVAC Enviro-Clean Condensate Drain Pan and Coil Cleaning System is designed to be installed at time of HVAC unit manufacture or may by installed into existing units by HVAC service repairmen, providing unit configuration permits. There are a number of potential breeding grounds for algae and microbial growth within a HVAC system. Routine maintenance may be performed by the HVAC user by adding a non-corrosive algaecide and cleaner fluid to the cooling coils and drain pan will inhibit the growth of algae and microbial matter in the HVAC unit and keep the cooling coils, drain pan and drain line clean and freely flowing.

It is desirable to prevent HVAC drain pans from overflowing and causing interior damage to homes and other buildings. Moisture damaged carpets which can remain wet for extended periods of time can cause unpleasant odors and can become a source of microbial and bacterial growth and become an ongoing detriment to Indoor Air Quality.

The claimed invention:

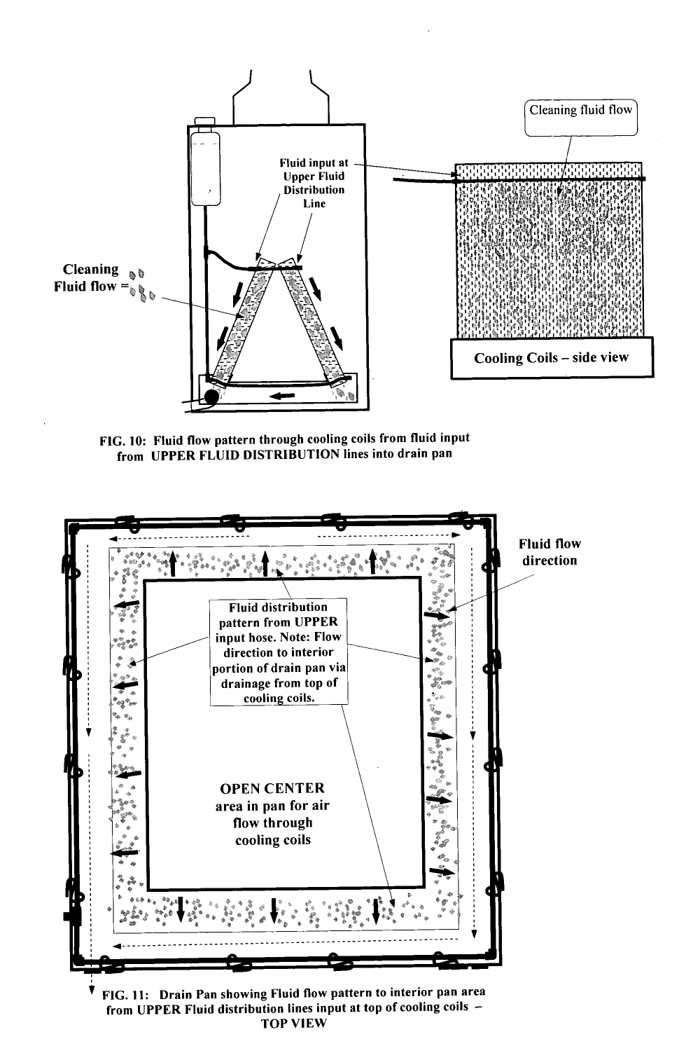

1. A gravity fed fluid delivery system installed in a HVAC unit and connected to the cooling coils and condensate drain pan for the introduction of non-corrosive cleaning and disinfectant fluids for the purpose of cleaning and disinfecting microbial growths on the cooling coils, condensate drain pan and drain line of a HVAC unit and is comprised of
a refillable internal plastic reservoir (see FIG. 2) having the external end covered by a removable plastic cap;
an outlet port on the downstream end of the reservoir which is connected to a ¼ inch plastic flow line and being further connected to a plastic barbed Tee fitting, and
an upper fluid flow system being connected to the first outlet of the Tee connector consisting of ¼ inch plastic non-perforated flow lines and perforated fluid distribution lines (Upper fluid lines) for delivery of fluids to the top portion of the cooling coils of the HVAC unit (see FIG. 10) to allow the introduction of cleaning fluids for sanitizing and removal of microbial growths on the cooling coils which are removed from the coils to the drain pan by downward fluid flow through the cooling coils and into the interior portion of the condensate drain pan (see FIG. 11), and
a fluid flow line connected to the distal end of the barbed Tee connector referenced hereinabove which delivers fluids to a second barbed Tee connector which is further attached to perforated plastic hoses (Lower fluid lines) attached to the exterior rim of the condensate drain pan for the purpose of treating microbial growths on the external portion of the condensate drain pan.

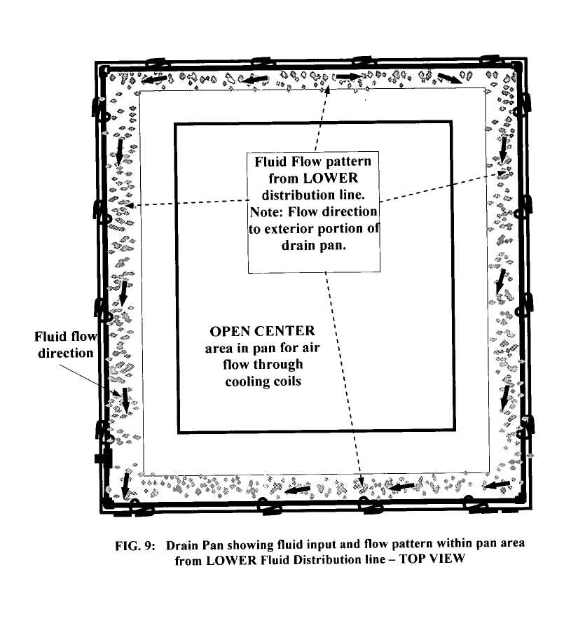

2. A plastic fluid collection device being rectangular pan (see FIGS. 8 & 9) placed beneath the cooling coils of a HVAC unit having an open center to allow for air flow through the center portion of the pan, having sloped bottoms from rear to front to an outlet port for connection to a condensate drain line outlet and a ¼ inch fluid flow line as described in claim 1 and having a system of ¼ inch plastic distribution soaker lines (see FIG. 9) (attached to the exterior sides of the condensate drain pan by means of plastic clips) through which the cleaning and disinfectant fluids are introduced to the exterior portion of the drain pan for cleaning and all fluids being further removed from the HVAC system through the condensate drain line to exterior disposal.
